(19) United States
(12) Patent Application Publication
(10) Pub. No.: US 2011/0065374 A1
(43) Pub. Date: Mar. 17, 2011

(54) Grille Cover and Contaminant Level Indicator

(76) Inventor: Ron Baihelfer, Narre Warren (AU)

(21) Appl. No.: 12/882,364

(22) Filed: Sep. 15, 2010

(30) Foreign Application Priority Data
Sep. 15, 2009 (AU) 2009904455

(51) Int. Cl. F24F 13/08; G01F 1/00; B29C 39/02; B29C 67/00

(52) U.S. Cl. 454/309; 73/861; 264/299; 264/571

(57) ABSTRACT

A disposable cover for an air flow grille of the type permitting air flow through a plurality of air flow openings in a predefined array of said openings, each said air flow opening having a forward inlet aperture and a passage wall extending from said forward opening to a discharge aperture on a downstream side of said air flow grille, said disposable cover being made from a thin walled mouldable plastics material having passage means corresponding to the predefined array of said openings in said air grille and being engageable therein during use of the disposable cover, said disposable cover, in use, covering at least forward facing regions of said air flow grille and at least a portion of each of the passage walls extending towards the discharge aperture on the downstream side of said air flow grille.

### FIELD OF THE INVENTION

The present invention relates to improvements in the field of return air grilles for air conditioning systems or the like.

### BACKGROUND OF THE INVENTION

It is known that return air ducts for air conditioning systems are typically covered by coarse mesh grilles aimed at providing minimal disturbance to air flow but preventing the passage of larger objects into the duct. In dirty environments where air entrained dust and other materials exist in reasonably high levels, the mesh covering the return air duct can become covered in this material to an extent where it can block or at least partially block the return air flow into the duct system leading to the air conditioning system. This commonly occurs in restaurant, cafe and other similar environments where cooking occurs but it can also occur in other environments. When the contaminant build up on the return air grille cover is sufficiently great, it is normal for the grille to be removed, cleaned of the contaminant material and returned to the operating position. This periodic cleaning of the grille is a quite expensive process. The objective of the present invention is to provide an arrangement usable with a return air grille or the like that will simplify the cleaning of same when necessary.

### SUMMARY OF THE INVENTION

According to a first aspect of the present invention, there is provided a disposable cover for an air flow grille of the type permitting air flow through a plurality of air flow openings in a predefined array of said openings, each said air flow opening having a forward inlet aperture and a passage wall extending from said forward opening to a discharge aperture on a downstream side of said air flow grille, said disposable cover being made from a thin walled mouldable plastics material having passage means corresponding to the predefined array of said openings in said air grille and being engageable therein during use of the disposable cover, said disposable cover, in use, covering at least forward facing regions of said air flow grille and at least a portion of each of the passage walls extending towards the discharge aperture on the downstream side of said air flow grille.

Preferably, the disposable cover may cover, in use, all of each of the passage walls. In a further possible arrangement, the disposable cover may extend, in use, beyond the downstream side of the air flow grille.

In a preferred arrangement, the air flow openings in the air flow grille may be square or rectangular and said disposable cover includes a plurality of thin walled tubular passage portions corresponding in position and shape to the square or rectangular air flow openings in the air flow grille, each of the tubular passage portions being open in a forward side and a rear side of the disposable cover. Conveniently a thin walled peripheral flange region surrounds the thin walled tubular passage portions. Preferably also a continuous flange region surrounds each of said tubular passage portions connecting said tubular passage portions to adjacent said tubular passage portions on said forward side.

By providing a disposable cover member of the above described type, it is possible, in use, to operationally install the cover member in any desired air flow grille and if and when it may become choked with contaminant materials it can simply be stripped from the air flow grille and replaced with a clean new disposable cover member. Thus cleaning of the air flow grille is simply and conveniently avoided with the costs of such disposable cover members being a very small percentage of the costs associated with cleaning such grilles.

In accordance with a second aspect of this invention, there is provided a method of making a disposable cover adapted, in use, to cover surface regions of an air flow grille, said method including the steps of:

moulding a thin sheet of plastics material in a mould representing an array of air flow openings in a predetermined air flow grille to form a discrete array of extended bubble formations corresponding to said array of air flow openings in the air flow grille; and

removing end regions of said extended bubble formations to produce a plurality of adjacent thin walled passage portions extending from a forward side to a rear side of said thin sheet of plastics material. Conveniently, the moulding step may be a vacuum moulding process, preferably including heating the plastics material sheet being formed.

Conveniently the step of removing the end regions of the extended bubble formations may occur either within the mould or after the disposable cover member has been removed from the mould. In the latter case, the length of the thin walled passage portions formed thereby might be made selectably variable. Preferably the mould may have an array of square or rectangular moulding cavities corresponding to the array of air flow openings in the predetermined air flow grille.

In a preferred arrangement an air flow sensor device might be employed with an air flow grille including a cover member installed in said air flow grille, the air flow sensor being adapted to sense when air flow levels drop to a level indicative that contaminant build up has occurred sufficient to suggest that the cover member and contaminant covering should be removed and replaced with a replacement cover member. In accordance with this proposal, the present invention also includes an air flow sensor usable with an air flow grille, to sense air flow through said grille below a predetermined volume rate, said sensor being mountable, in use, on a downstream side of said air flow grille and includes a flow passage to receive air flow through said grille, said sensor further including a first member subject to air flow through said air flow passage connected to an indicator member normally held within the air flow grille or an upstream side of the airflow grille, said indicator member being movable to an upstream side of the air flow grille when said first member receives air flow from said air flow passage below said predetermined volume rate. In this manner, once the indicator member moves to the upstream side of the air flow grille, this will indicate contamination levels are likely to be blocking the air flow grille and then the protective cover member with the blocking contaminants can be removed and replaced.

Several preferred embodiments of the present invention are described hereafter with reference to the accompanying drawings.

### BRIEF DESCRIPTION OF THE DRAWINGS

FIG. 1 is a partial section view of a mould or sheet of plastics material to be formed in the mould to produce a cover member;

FIG. 2 is a view similar to FIG. 1 after a first step of the moulding process;

FIG. 3 shows a view similar to FIG. 2 after a further step in the manufacturing process has been carried out;

FIG. 4 is a view similar to the previous drawings showing the formed cover member removed from the mould;

FIG. 5 is a partial upper perspective view of the cover member shown in FIG. 4; and

FIG. 6 shows diagrammatically a sensor device for sensing air flow through an air flow grille with an installed cover member as depicted in earlier drawings.

### DESCRIPTION OF THE PREFERRED EMBODIMENTS

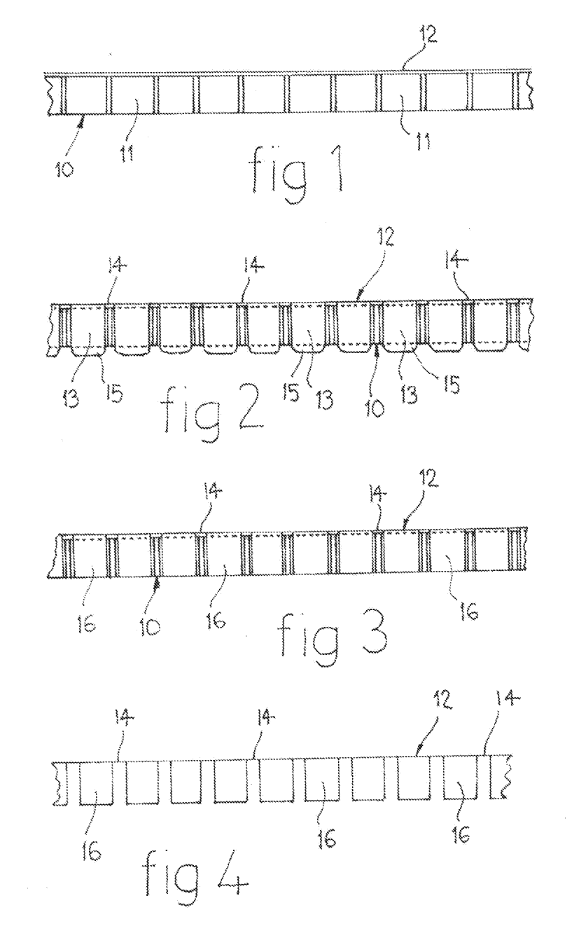

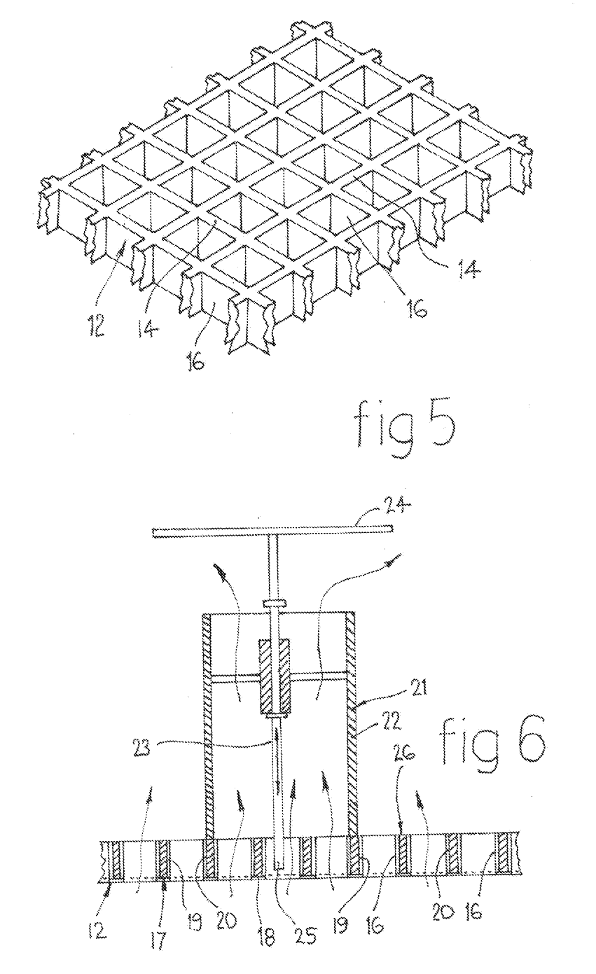

Referring to the drawings, FIG. 1 shows a mould 10 with an array of mould cavities 11. The cross-sectional shape of the mould cavities 11 (into the paper) is square as is conventional for return air grilles in air conditioning systems. The cross-sectional shape could be rectangular or potentially other shapes consistent with the air flow grille that the cover member is intended to be used with. The physical array of the mould cavities is identical to the air flow passages in the air flow grille that the cover member is intended to be used with. FIG. 1 also shows a sheet of heat formable plastics material 12 positioned above the mould 10. As shown in FIG. 2, the sheet 12 is vacuum moulded into the mould cavities 11 to form a plurality of extended bubble formations 13 each connected to one another by a continuous flange material 14. The extended bubble formations 13 may extend beneath the mould 10 such that their end regions 15 might be removed by any suitable technique such as milling or cutting (FIG. 3). This step might be performed while the cover member 12 is retained within the mould 10 or it may be stripped from the mould 10 and performed as a separate operation elsewhere. In either case a cover member 12 as shown in FIGS. 4 and 5 may be produced consisting of tubular passage portions 16 open at the top and the bottom and having a cross-sectional shape identical to that of the mould cavities 11 and thereby the air flow openings in the desired air flow grille. Conveniently a flat peripheral flange (not shown in the drawings) may be provided around the array of tubular passage portions 16. In practice the cover member will have a size and configuration to completely cover the upstream side 18 of an air flow grille 17 (FIG. 6) with the tubular passage portions 16 fitting into and being engaged with the air flow openings 19 in the grille 17. It is believed that friction between the tubular passage portions 16 and the passage walls 20 of the air flow openings 19 will be sufficient to operationally hold the cover member 12 in position. If this may not be the case, then separate fastener or adherence means might be employed between the cover member 12 and the grille 17. If such means is used, then they would still need to be releasable as, once used, the cover member would need to be removable once contaminants have accumulated therein to an undesirable stage.

FIG. 6 also illustrates diagrammatically, a sensor device 21 for sensing air flow rates through the air flow grille 17 and installed cover member 12. The sensor device 21 includes a tubular flow passage 22 which may include fastener means (not shown) of any suitable type to connect the tubular flow passage 22 to the downstream face 26 of the grille 17. The device 21 includes a slide indicator 23 having an upper disc member 24 secured thereto that receives air flow through the passage 22 to push the disc member 24 upwardly (as illustrated). In this configuration, air flow through the grille 17 is not obstructed by contaminant build up. Once air flow drops to a predetermined level as a result of contaminants building up on the cover member 12, the disc member 24 will no longer hold its illustrated position and the slide indicator 23 will drop downwardly. The free lower end 25 of the slide indicator 23 will eventually project upstream of the grille 17 to indicate that the grille has been blocked sufficiently to require removal and replacement of the cover member 12.

While the drawings illustrate the presently preferred embodiments, many modifications or changes to the illustrated features might also be employed. In relation to the sensor device the disc member 24 might be added to with weights or decreased in size by having portions removable to thereby adjust the sensor for particular applications. While the drawings illustrate the cover member 12 covers the upstream side of the grille 17 and all parts thereof to the downstream face of the grille 17, in some cases the cover member might have thicker or thinner dimensions. Other possible variations will be apparent to those skilled in the art.

1. A disposable cover for an air flow grille of the type permitting air flow through a plurality of air flow openings in a predefined array of said openings, each said air flow opening having a forward inlet aperture and a passage wall extending from said forward opening to a discharge aperture on a downstream side of said air flow grille, said disposable cover being made from a thin walled mouldable plastics material having passage means corresponding to the predefined array of said openings in said air grille and being engageable therein during use of the disposable cover, said disposable cover, in use, covering at least forward facing regions of said air flow grille and at least a portion of each of the passage walls extending towards the discharge aperture on the downstream side of said air flow grille.

2. A disposable cover according to claim 1 wherein the disposable cover covers, in use, all of each of said passage walls.

3. A disposable cover according to claim 2 wherein the disposable cover extends, in use, beyond the downstream side of said air flow grille.

4. A disposable cover according to claim 1 wherein the air flow openings in the air flow grille are square or rectangular and said disposable cover includes a plurality of thin walled tubular passage portions corresponding in position and shape to the square or rectangular air flow openings in the air flow grille, each said tubular passage portion being open on a forward side and a rear side of said disposable cover.

5. A disposable cover according to claim 4 further including a thin walled peripheral flange region surrounding said thin walled tubular passage portions.

6. A disposable cover according to claim 4 wherein a continuous flange region surrounds each of said tubular passage portions connecting said tubular passage portions to adjacent said tubular passage portions on said forward side.

7. A method of making a disposable cover adapted, in use, to cover surface regions of an air flow grille, said method including the steps of:
moulding a thin sheet of plastics material in a mould representing an array of air flow openings in a predetermined air flow grille to form a discrete array of extended bubble formations corresponding to said array of air flow openings in the air flow grille; and
removing end regions of said extended bubble formations to produce a plurality of adjacent thin walled passage portions extending from a forward side to a rear side of said thin sheet of plastics material.

8. A method of making a disposable cover according to claim 7 wherein said moulding step is a vacuum moulding process.

9. A method according to claim 7 wherein the step of removing end regions of said extended bubble formations occurs while the disposable cover is held within said mould.

10. A method according to claim 7 wherein the step of removing end regions of said extended bubble formations occurs after the disposable cover has been removed from said mould.

11. A method according to claim 7 wherein said mould has an array of square or rectangular moulding cavities corresponding to the array of air flow openings in the predetermined air flow grille.

12. An air flow sensor usable with an air flow grille, to sense air flow through said grille below a predetermined volume rate, said sensor being mountable, in use, on a downstream side of said air flow grille and includes a flow passage to receive air flow through said grille, said sensor further including a first member subject to air flow through said air flow passage connected to an indicator member normally held within the air flow grille or an upstream side of the air flow grille, said indicator member being movable to an upstream side of the air flow grille when said first member receives air flow from said air flow passage below said predetermined volume rate.
